(19) United States
(12) Patent Application Publication
(10) Pub. No.: US 2011/0168876 A1
(43) Pub. Date: Jul. 14, 2011

(54) OPTICAL MODULE AND SYSTEM FOR LIQUID SAMPLE

(76) Inventors: Hsiung Hsiao, Hsinchu (TW); KuoTong Ma, Hsinchu (TW)

(21) Appl. No.: 12/687,572

(22) Filed: Jan. 14, 2010

(51) Int. Cl. H01J 40/14; G01J 1/04

(52) U.S. Cl. 250/215; 250/227.11

(57) ABSTRACT

The present invention relates to an optical module and system for a liquid sample, and more particularly to an optical module and system for measuring a property of a liquid sample. The optical system comprises a substrate, a laser source, at least one photo detector, and a microprocessor, wherein the substrate comprises a sample surface at the top, a light-out surface, and an extruded light guide block with a light-in surface at the bottom. The extruded light guide block guides light from the light-in surface to the sample surface with a useful incident angle. In the present invention, the analysis can be processed with the normalized intensities of the reflected and scattered light for enhancing the accuracy of the system.

### FIELD OF THE INVENTION

The present invention relates to an optical module and system for a liquid sample, and more particularly to an optical module and system for measuring a property of a liquid sample.

### BACKGROUND OF THE INVENTION

The Brix value of a pure liquid substance is a constant under standard conditions of temperature and pressure. For a solution, the total Brix value is approximately equal to the sum of the Brix values of the individual components. In other words, the molar fractions of the components in a mixed sample closely correlate with the Brix value contributions of each component to the total Brix value.

Brix value can be used to determine the concentration of a great number of solutions, such as drugs, food, fruit juices, cosmetics, and so on. And the Brix value of a solution can be determined by using a refractometer.

Referring to FIG. 1, there is shown a cross-sectional view of a conventional refractometer according to the US patent application 20040145731.

The refractometer 10 comprises a sample stage 18, a prism 12, a light emitting diode (LED) 14, a barrier 141, and a charge coupled device (CCD) 16. The prism 12 comprises an interface surface 125, a first surface 121, and a second surface 123. The interface surface 125 is attached to the bottom of the sample stage 18. There is an opening at the center of the sample stage 18, such that a liquid sample 19 can be put on the interface surface 125 of the prism 12.

The LED 14 is configured to provide light through a hole 143 of the barrier 141 to the prism 12 with a small diffusion angle θ. The incident light Ri is directed from the first surface 121 to the desired region of the interface surface 125. The reflected light Rr can be received in some region of the CCD 16.

By analyzing the light pattern received by the CCD 16, the total reflection angle can be determined, and then the refractive index and the Brix value can be determined, too.

For the conventional refractometer 10, an accurate optical alignment is necessary for the system, and each surface of the prism 12 must be smooth enough, too. Furthermore, the conventional refractometer 10 determines the solution only by the total reflection angle, it is imposable for the refractometer 10 to determine whether the solution comprises suspended particles or not.

Referring to FIG. 2, there is shown a cross-sectional view of an optical sensor according to the U.S. Pat. No. 5,396,325.

The optical sensor 20 comprises a LED 24 coupled to a transparent sensing element 22 by means of a first optical fiber 261, and a photo detector 28 coupled to the element 22 by means of a second optical fiber 263. The element 22 is a thin glass plate having a planar light-incident surface 223 parallel to a planar measuring surface 221.

The optical fiber 261 is fixed to the light-incident surface 223 at the position 235 so that optical energy transmitted from the LED 24 through the fiber 261 is directed through the element 22 to the measuring surface 221 with an incident angle θᵢ. The optical fiber 263 is fixed to the light-incident surface 223 at position 237 to receive a sample of optical energy transmitted through the element 22 away from the measuring surface 221 with a reflected angle θᵣ.

The measuring surface 221 is brought into contact with a substance 29. Optical energy from the fiber 261 is incident on the measuring surface 221, partial of the optical energy is transmitted into the substance 29, and partial of the optical energy is reflected to the photo detector 28 through the fiber 263. The intensity of optical energy received by the photo detector 28 is a function of the refractive index of the substance 29. By analyzing the intensity of optical energy received by the photo detector 28, the refractive index of the substance 29 is obtained.

For the optical sensor 20 described above, an LED provides optical energy divergently, such that the optical sensor operates inefficiently.

Although the inventor of U.S. Pat. No. 5,396,325 claims that a laser diode can be used to provide optical energy for the optical sensor 20, a lot of experiments prove that the optical sensor 20 cannot work with a laser diode.

### SUMMARY OF THE INVENTION

It is an objective of the present invention to provide an optical module and system for measuring a property of a liquid sample.

It is another objective of the present invention to provide an optical module and system for measuring a property of a liquid sample, wherein the substrate comprises an extruded light guide block including a light-in surface for guiding light from the laser source to the sample surface with a useful incident angle.

It is another objective of the present invention to provide an optical module and system for measuring a property of a liquid sample, wherein the light-in surface and the normal of the substrate comprises an included angled between 24 degree and 48 degree.

It is another objective of the present invention to provide an optical module and system for measuring a property of a liquid sample, wherein the substrate and the extruded light guide block is made of transparent or semi-transparent material with the refractive index between 1.46 and 1.61.

It is another objective of the present invention to provide an optical module and system for measuring a property of a liquid sample, wherein the substrate and the extruded light guide block is made of one of polycarbonate, polymethyl methacrylate, polystyrene, polyacrylate, cellulous, styrene, or glass.

It is another objective of the present invention to provide an optical module and system for measuring a property of a liquid sample comprising two photo detectors for detecting reflected and scattered light.

It is another objective of the present invention to provide an optical system for measuring a property of a liquid sample, wherein the analysis is processed with the normalized intensities of the reflected and scattered light for enhancing the accuracy of the system.

The present invention provides an optical module for measuring a property of a liquid sample, comprising: a substrate with a sample surface at the top for retaining a target liquid sample, a light-out surface, and an extruded light guide block at the bottom, the light guide block including a light-in surface; a laser source for providing light through the light-in surface to the sample surface; and a photo detector coupled to the light-out surface for receiving light reflected from the sample surface.

The present invention further provides an optical system for measuring a property of a liquid sample, comprising: a substrate with a sample surface at the top for retaining a target liquid sample, a light-out surface and an extruded light guide block at the bottom, the light guide block including a light-in surface; a laser source for providing light through the light-in surface to the sample surface; a photo detector coupled to the light-out surface for receiving light reflected from the sample surface, and generating a reflected signal; and an operation unit coupled to laser source and the photo detector for analyzing the property of the target liquid sample.

### BRIEF DESCRIPTION OF THE DRAWINGS

FIG. 1 is a cross-sectional view of a conventional refractometer.

FIG. 2 is a cross-sectional view of a conventional optical sensor.

FIG. 3 shows the behavior of light at the interface of a liquid and the substrate.

FIG. 4 is a cross-sectional view of an optical module in accordance with an embodiment of the present invention.

FIG. 5 is a cross-sectional view of an optical module in accordance with another embodiment of the present invention.

FIG. 6 is a cross-sectional view of an optical module in accordance with another embodiment of the present invention.

FIG. 7 is a cross-sectional view of an optical module in accordance with another embodiment of the present invention.

FIG. 8 is a cross-sectional view of an optical module in accordance with another embodiment of the present invention.

FIG. 9 is a cross-sectional view of an optical module in accordance with another embodiment of the present invention.

FIG. 10 is a schematic diagram of an optical system for measuring a property of a liquid sample in accordance with an embodiment of the present invention.

FIG. 11 is a graph of a sucrose solution showing the relationship of the Brix value and the normalized intensity of the reflected light, and the normalized intensity of the scattered light.

FIG. 12 is a graph of a milk solution showing the relationship of the Brix value, the normalized intensity of the reflected light, and the normalized intensity of the scattered light.

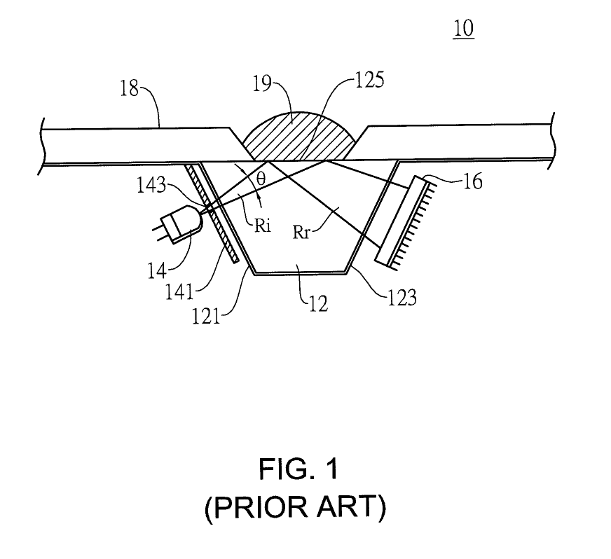

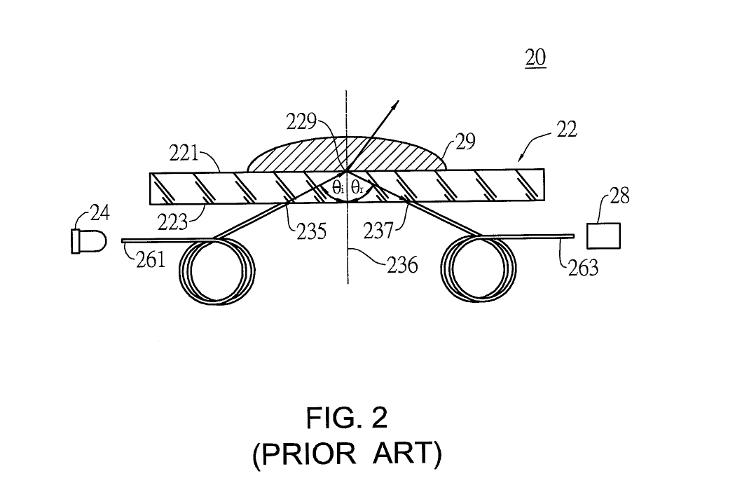

### DETAILED DESCRIPTION OF DISCLOSED EMBODIMENTS

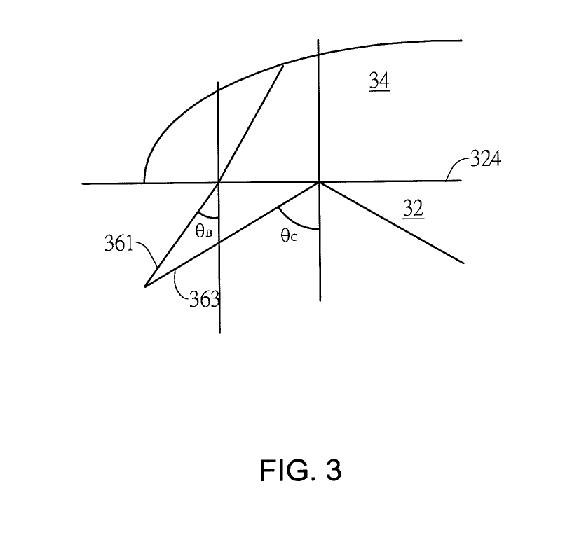

Referring to FIG. 3, there is shown the behavior of light at the interface of a liquid and the substrate.

When light 361 with a particular polarization is projected from the substrate 32 to the interface 324 with an incident angle θ_{B}, and it is perfectly transmitted through the interface 324 to the liquid 34 without reflection. The angle θ_{B} is called the Brewster's angle. According to the Snell's law, we have the formula:

θ_{B}=arc tan(n_{L}/n_{S}).

Wherein n_{L} is the refractive index of the liquid sample 34, n_{S} is the refractive index of the substrate 32.

On the other hand, when light 363 is projected from the substrate 32 to the interface 324 with an incident angle θ_{C}, and it is totally reflected, no light passes through the interface 324 to the liquid sample 34. The angle θ_{C} is called the critical angle. According to some physical induction, we have the formula:

θ_{C}=arc sin(n_{L}/n_{S}).

When the incident angle of light is restricted between the Brewster's angleθ_{B} and the critical angleθ_{C}, a portion of light will pass through the interface 324 to the liquid sample 34, and the rest of light will be reflected.

The intensity of light passing through the interface 324 is a function of the refractive index of the liquid sample 34, and the intensity of reflected light is also a function of the refractive index of the liquid sample 34. With the restriction, light reflected from the interface 324 can bring the useful information of the liquid sample 34.

For the common applications, the refractive index of liquid sample 34 is between 1.33 and 1.44, and the refractive index of the substrate 32 is between 1.46 and 1.61. The light projected to the interface 324 with the incident angle between 24 degree and 48 degree, and the useful information of the liquid sample 34 can be carried by the reflected light.

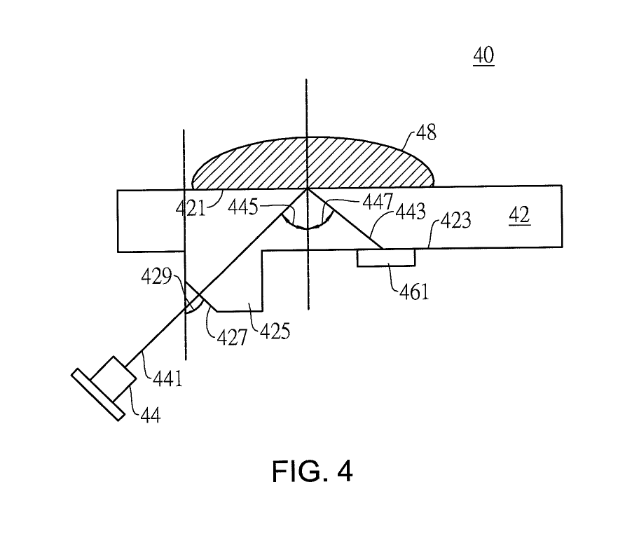

Referring to FIG. 4, there is shown a cross-sectional view of an optical module in accordance with one embodiment of the present invention. The optical module 40 of the present invention comprises a substrate 42, a laser source 44, and a photo detector 461.

The substrate 42 comprises a sample surface 421 at the top, a light-out surface 423 at the bottom, and further comprises an extruded light guide block 425 at the bottom. The sample surface 421 is used for retaining a liquid sample 48 and forming a liquid-solid interface. The extruded light guide block 425 includes a light-in surface 427 for guiding light 441 provided by the laser source 44 to the sample surface 421.

The light-in surface 427 and the normal of the substrate comprise an included angle 429 between 24 degree and 48 degree. The reflected light 443 with reflected angle 447 (equal to the incident angle 445) will bring the useful information through the light-out surface 423 to the photo detector 461.

In the present invention, the substrate 42 with the extruded light guide block 425 is made of transparent or semi-transparent material with the refractive index between 1.46 and 1.61. The transparent or semi-transparent material can be selected from one of polycarbonate, polymethyl methacrylate, polystyrene, polyacrylate, cellulous, styrene, glass or quartz.

The wavelength of light 441 provided by the laser source 44 is from 300 nm to 1500 nm, preferably from 400 nm to 1350 nm, and most preferably from 600 nm to 800 nm.

Light 441 provided by the laser source (such as a laser diode) 44 is projected through the light-in surface 427 of the extruded light guide block to the sample surface 421.

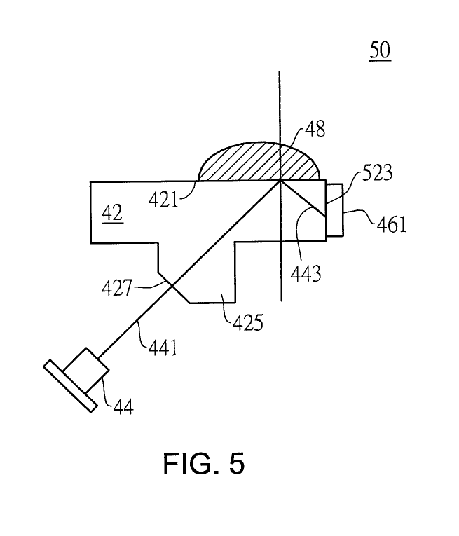

Referring to FIG. 5, there is shown a cross-sectional view of an optical module for measuring a property of a liquid sample in accordance with another embodiment of the present invention. The optical module 50 of the present embodiment is similar to the embodiment shown in FIG. 4. The optical module 50 of the present embodiment comprises a light-out surface 523 on the lateral side of the substrate 42, and the photo detector 461 is coupled to the light-out surface 523 for receiving the reflected light 443 from the sample surface 421.

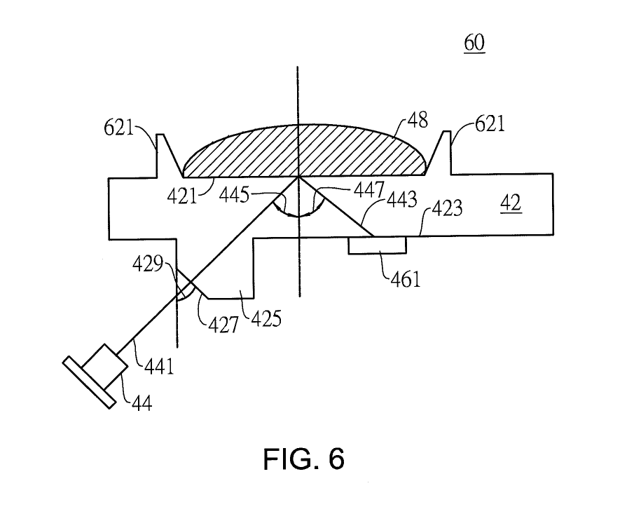

Referring to FIG. 6, there is shown a cross-sectional view of an optical module for measuring a property of a liquid sample in accordance with another embodiment of the present invention. The optical module 60 of the present embodiment is similar to the embodiment shown in FIG. 4. The optical module 60 of the present embodiment further comprises an encircling wall 621 located on the sample surface 421. The encircling wall 621 is made of the same material with the substrate 42, and is used for retaining the target liquid sample 48 in the predetermined region.

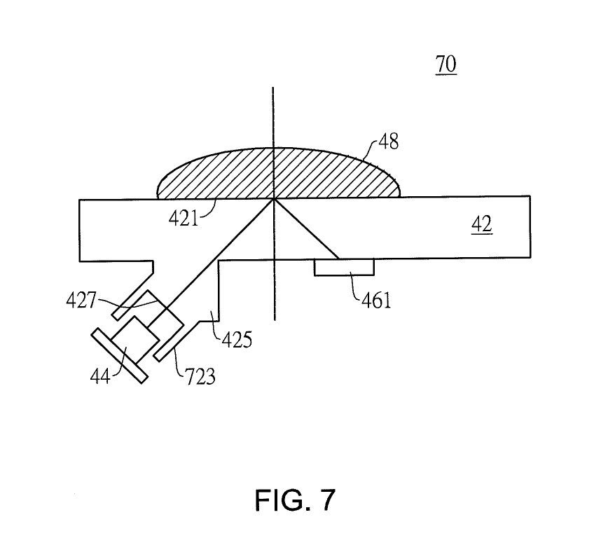

Referring to FIG. 7, there is shown a cross-sectional view of an optical module for measuring a property of a liquid sample in accordance with another embodiment of the present invention. The optical module 70 of the present embodiment is similar to the embodiment shown in FIG. 4. The optical module 70 of the present embodiment further comprises a sleeve 723 located on the light-in surface 427. The sleeve 723 is made of the same material with the substrate 42, and is used for enveloping the laser source 44.

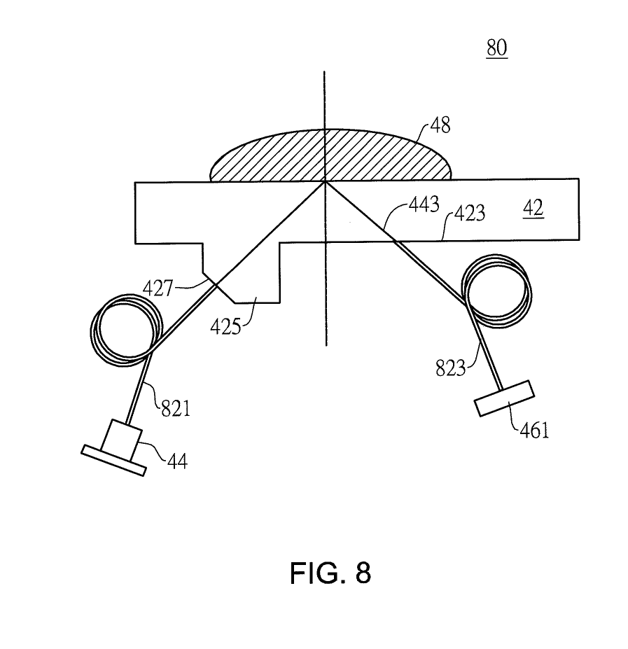

Referring to FIG. 8, there is shown a cross-sectional view of an optical module for measuring a property of a liquid sample in accordance with another embodiment of the present invention. The optical module 80 of the present embodiment is similar to the embodiment shown in FIG. 4. The optical module 80 of the present embodiment further comprises a first optical fiber 821 and a second optical fiber 823.

The first fiber 821 is disposed between the laser source 44 and the light-in surface 427 for guiding light from the laser source 44 to the light-in surface 427. The second fiber 823 is disposed between the light-out surface 423 and the photo detector 461 for guiding the reflected light 443 from the light-out surface 423 to the photo detector 461.

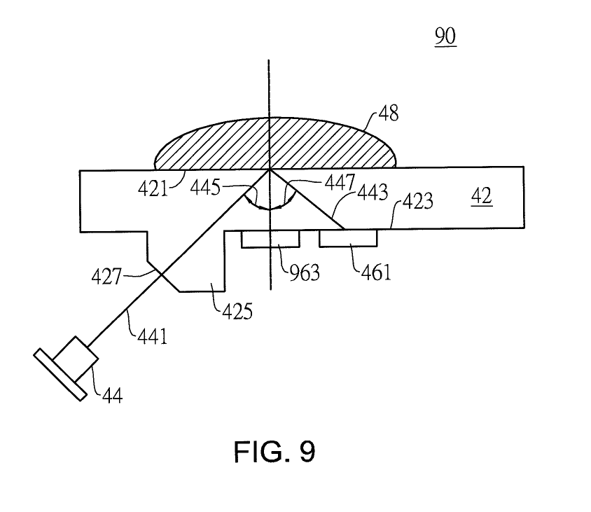

Referring to FIG. 9, there is shown a cross-sectional view of an optical module for measuring a property of a liquid sample in accordance with still another embodiment of the present invention. The optical module 90 of the present embodiment is similar to the embodiment shown in FIG. 4. The optical module 90 of the present embodiment further comprises a second photo detector 963.

The second photo detector 963 is coupled to the light-out surface 423 out of the reflected light path for receiving light that is scattered by the target liquid sample 48. By detecting the scattered light, the system can determine whether the solution comprises suspended particles or not. The intensity of the scattered light also comprises useful information of the target liquid sample 48.

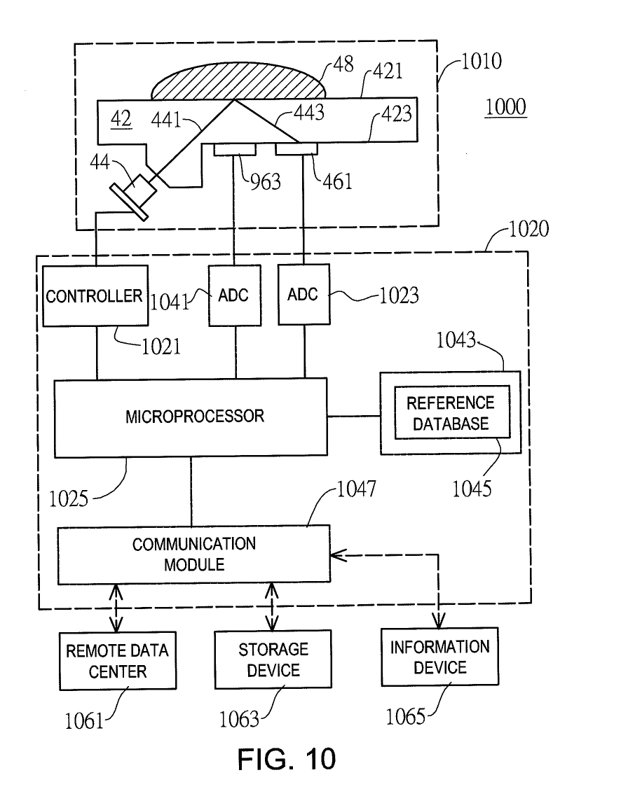

Referring to FIG. 10, there is shown a schematic diagram of an optical system for measuring a property of a liquid sample in accordance with an embodiment of the present invention. The optical system 1000 comprises an optical module 1010 and an operation unit 1020.

The optical module 1010 is selected from one of the aforementioned embodiments. When the optical module 1010 is selected to be the embodiment shown in FIG. 4, it comprises a substrate 42 with an extruded light guide block 425, a laser source 44, and a photo detector 461.

The operation unit 1020 comprises a controller 1021, a analog-to-digital converter (ADC) 1023, and a microprocessor 1025.

The controller 1021 is coupled to the laser source 44 for adjusting the intensity of light output from the laser source 44 according to an output data. The ADC 1023 is coupled to the photo detector 461. The microprocessor 1025 is coupled to the controller 1021 and the ADC 1023.

When the photo detector 461 receives the reflected light, a reflected signal according to the intensity of the reflected light is generated and transmitted to the ADC 1023. The ADC 1023 converts the reflected signal to a digital reflected data. The microprocessor 1025 receives the reflected data, and analyzes the property of the target liquid sample 48 according to the output data.

In one embodiment of the present invention, the operation unit 1020 comprises a second photo detector 963 and a second ADC 1041. The second photo detector 963 is disposed at the light-out surface 423 out of the reflected light path. The second ADC 1041 is coupled to the second photo detector 963 and the microprocessor 1025. When the target liquid sample 48 is turbid, light 441 projected to sample surface 421 will be refracted, reflected, and also scattered. The second photo detector 963 receives the scattered light and generates a scattered signal accordingly. The second ADC 1041 is used for converting the scattered signal to a digital scattered data. The microprocessor 1025 receives the reflected data and scattered data, and analyzes the property of the target liquid sample 48 according to the output data.

In the present invention, the analysis is processed with the normalized intensity that is the intensity of the reflected light or/and scattered light divided by the intensity of light provided by the laser source 44. This will enhance the accuracy of the optical system 1000.

The operation unit 1020 can further comprise a storage element 1043 coupled to the microprocessor 1025, wherein the storage element 1043 includes a reference database 1045 of a liquid sample. The reference database 1045 comprises normalized reflected intensity, normalized scattered intensity, and the corresponding Brix value or/and refractive index of a liquid sample.

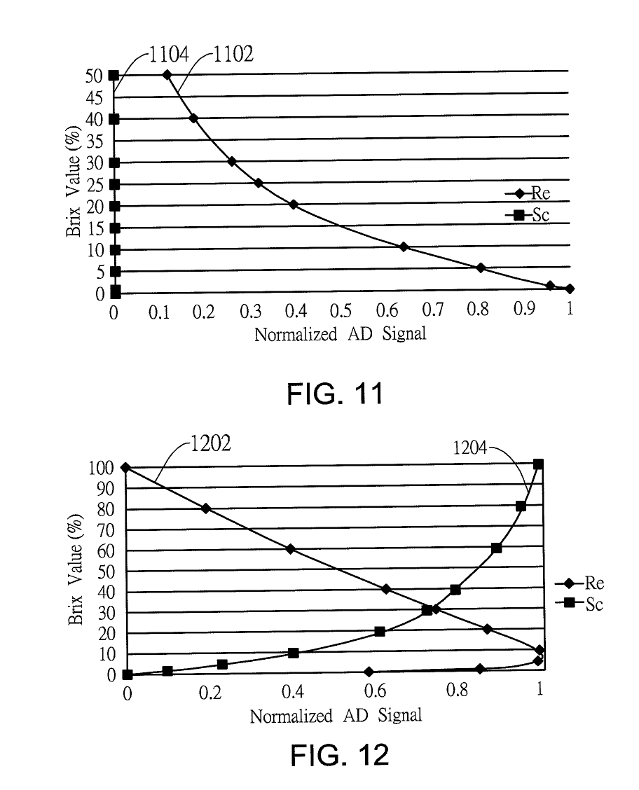

For example, the reference database of a sucrose solution comprises the Brix value and the corresponding normalized intensities of reflected and scattered light, as shown in FIG. 11. According to the reference database, the curve of the reflected light 1102 and the curve of the scattered light 1104 are obtained. Since the sucrose solution is clear, the intensity of the scattered light is always 0.

The reference database of a milk solution comprises the Brix value and the corresponding normalized intensities of reflected and scattered light, as shown in FIG. 12. According the reference database, the curve of the reflected light 1202 and the curve of the scattered light 1204 are obtained.

For analysis, the microprocessor 1025 calculates the normalized reflected intensity of the target liquid sample 48 according to the reflected data and the output data. And then, a polynomial regression analysis is processed by the microprocessor 1025 to fit the normalized reflected intensity to the curve. And the property of the target liquid sample 48, such as the Brix value, refractive index, or concentration, can be obtained.

The microprocessor 1025 also calculates both the normalized reflected intensity and normalized scattered intensity of the target liquid sample 48 according to the reflected data, scattered data, and the output data. And then, a polynomial regression analysis is processed by the microprocessor 1025 to fit the normalized reflected intensity and normalized scattered intensity to the curves. And the property of the target liquid sample 48, such as the Brix value, refractive index, or concentration, can be obtained and the accuracy will be enhanced.

In one embodiment of the present invention, the operation unit 1020 can further comprise a communication module 1047 coupled to the microprocessor 1025. The communication module 1047 is used for communicating with a support device, such as a remote data center 1061, a storage device 1063, or an information device 1065. Support devices provide reference database of a plurality of liquid samples for the optical system 1000 to analyze or update the reference database 1045 in the storage element 1043.

The information device 1065 is selected from one of a mobile phone, a PDA, a notebook, or a PC. The optical system 1000 communicates with the information device 1065 through wire or wireless connection. The information device 1065 provides reference database of liquid sample for updating the reference database 1045 of the optical system 1000, or receives the normalized reflected intensity or/and normalized scattered intensity from the optical system 1000 for analyzing the property of the target liquid sample 48. The storage device 1063 is selected from one of a memory card, a hard disk drive, a removable hard disk drive, or an usb flash drive.

The optical system 1000 of the present invention can be used for real-time monitoring in a fabrication process. The optical module 1010 can be easily fixed to a fabrication apparatus. When the liquid product flows through the sample surface 421, the properties of the liquid product are analyzed immediately. Furthermore, the optical system 1000 can be used for counterfeit recognition by comparing the properties of the target liquid sample 40 with the properties of a standard liquid sample.

The present invention is not limited to the above-described embodiments. Various alternatives, modifications and equivalents may be used. Therefore, the above embodiments should not be taken as limiting the scope of the invention, which is defined by the appending claims.

What is claimed is:

1. An optical module for measuring a property of a liquid sample, comprising:
a substrate with a sample surface at the top for retaining a target liquid sample, a light-out surface, and an extruded light guide block at the bottom, the light guide block including a light-in surface;
a laser source for providing light through the light-in surface to the sample surface; and
a photo detector coupled to the light-out surface for receiving light reflected from the sample surface.

2. The optical module of claim 1, further comprising a second photo detector coupled to the light-out surface for receiving light scattered from the sample surface.

3. The optical module of claim 1, wherein the light-out surface is defined at the bottom of the substrate or on the lateral side of the substrate.

4. The optical module of claim 1, wherein the substrate is made of transparent or semi-transparent material with the refractive index between 1.46 and 1.61.

5. The optical module of claim 1, wherein the substrate is made of one of polycarbonate, polymethyl methacrylate, polystyrene, polyacrylate, cellulous, styrene, glass or quartz.

6. The optical module of claim 1, further comprising an encircling wall located on the sample surface to retain the target liquid sample, and the material of the substrate and the encircling wall are substantially the same.

7. The optical module of claim 1, wherein the light-in surface and the normal of the substrate comprise an included angle between 24 degree and 48 degree.

8. The optical module of claim 1, wherein the wavelength of light provided by the laser source is from 300 nm to 1500 nm.

9. The optical module of claim 8, wherein the wavelength of light provided by the laser source is preferably from 600 nm to 800 nm.

10. The optical module of claim 1, further comprising a sleeve located on the light-in surface for enveloping the laser source.

11. The optical module of claim 1, further comprising a first fiber for guiding light from the laser source to the light-in surface.

12. The optical module of claim 1, further comprising a second fiber for guiding the reflected light from the light-out surface to the photo detector.

13. The optical module of claim 1, wherein the material of the substrate and the extruded light guide block are substantially the same.

14. An optical system for measuring a property of a liquid sample, comprising:
a substrate with a sample surface at the top for retaining a target liquid sample, a light-out surface and an extruded light guide block at the bottom, the light guide block including a light-in surface;
a laser source for providing light through the light-in surface to the sample surface;
a photo detector coupled to the light-out surface for receiving light reflected from the sample surface, and generating a reflected signal; and
an operation unit coupled to laser source and the photo detector for analyzing the property of the target liquid sample.

15. The optical system of claim 14, wherein the light-out surface is defined at the bottom of the substrate or on the lateral side of the substrate.

16. The optical system of claim 14, wherein the operation unit comprises:
a controller coupled to the laser source for adjusting the intensity of light output from the laser source according to an output data;
a analog-to-digital converter coupled to the photo detector for converting the reflected signal to a reflected data;
a microprocessor coupled to the controller and the analog-to-digital converter for receiving the reflected data and analyzing the property of the target liquid sample according to the output data.

17. The optical system of claim 16, further comprising a second photo detector coupled to the light-out surface for receiving light that scattered from the sample surface, and generating a scattered signal; and the operation unit further comprising a second analog-to-digital converter coupled to the second photo detector and the microprocessor for converting the scattered signal to a scattered data.

18. The optical system of claim 17, wherein the operation unit further comprises a storage element coupled to the microprocessor, wherein the storage element includes a reference database of a liquid sample.

19. The optical system of claim 17, wherein the operation unit further comprises a communication module coupled to the microprocessor for communicating with a support device.

20. The optical system of claim 19, wherein the support device is selected from one of a storage device, an information device, or a remote data center including a reference database of a liquid sample.
